(19) United States
(12) Patent Application Publication
(10) Pub. No.: US 2023/0012473 A1
(43) Pub. Date: Jan. 19, 2023

(54) AIRBAG DEVICE FOR AIRCRAFT

(71) Applicant: NIPPON KAYAKU KABUSHIKI KAISHA, Tokyo (JP)

(72) Inventors: Hiroshi NAKAMURA, Tokyo (JP); Yasuhiko YAGIHASHI, Tokyo (JP); Kouichi SASAMOTO, Tokyo (JP)

(21) Appl. No.: 17/818,364

(22) Filed: Aug. 9, 2022

Related U.S. Application Data
(63) Continuation-in-part of application No. 16/471,568, filed on Jun. 20, 2019, now abandoned.

(30) Foreign Application Priority Data
Dec. 20, 2016 (JP) 2016-247225

(51) Int. Cl. B64D 45/00; H01M 50/244; H01M 50/249; H01M 50/24

(52) U.S. Cl. CPC B64D 45/00; H01M 50/244; H01M 50/249; H01M 50/24; B64C 39/024

(57) ABSTRACT

Provided is an airbag device for a flying object sufficiently having a performance of protecting a battery.

An airbag device 1 is an airbag device for a flying object including an upper cover member 19 and a lower cover member 20 as a housing, and a battery 24 provided inside the housing and includes an expandable member 2 which is provided inside the housing of the flying object 10 and is expandable inside the housing, a gas generator 3 which is connected to the expandable member 2 and receives a predetermined amount of current to make gas flow into the expandable member 2, and a current supply section which supplies current to the gas generator 3 according to collision of the flying object 10.

### TECHNICAL FIELD

The present invention relates to an airbag device mounted on a flying object.

### BACKGROUND ART

In recent years, with the development of flight control technology, an industrial use of flying objects equipped with a plurality of rotor blades, for example, called drone, is accelerating. Such flying objects are expected to expand worldwide in the future.

On the other hand, the risk of fall accidents of flying objects as described above is considered to be dangerous and hinders spread of the flying objects. A background where the risk of such a fall accident is considered to be dangerous is considered to be related to the possibility that a lithium ion battery mounted on a flying object may be ignited by falling impact. Importance of battery protection is becoming an international consensus. It is important to protect other devices (such as various sensors, safety devices, and flight control devices) mounted on flying objects.

Thus, in order to reduce falling impact on a flying object, it has been proposed that the flying object is provided with an airbag. For example, Patent Literature 1 describes that an airbag is provided at a lower portion of a multicopter (helicopter) as a flying object.

### CITATIONS LIST

### Patent Literature

Patent Literature 1: Japanese Published Unexamined Patent Application-A No. 2016-088111

### SUMMARY OF INVENTION

### Technical Problems

However, since the airbag provided in the multicopter described in Patent Literature 1 is large enough to reach a region over the entire lower portion of the multicopter when the airbag inflates, the total weight of the airbag is heavy. As a result, the flight performance is significantly reduced. In the technology of Patent Literature 1, it is difficult to individually protect each device mounted on a flying object.

Thus, an object of the present invention is to provide an airbag device for a flying object, which sufficiently has a performance of protecting each device mounted on the flying object.

### Solutions to Problems

(1) The present invention is an airbag device for a flying object, which protects at least one of objects to be protected mounted on the flying object, and the airbag device includes an airbag, which is provided adjacent to at least one of the objects to be protected mounted on the flying object, is contracted or folded in an initial state, and is deployable so as to cover a portion or the entirety of a periphery of the object to be protected mounted on the flying object when the airbag is inflated and a gas generator which is connected to the airbag and is capable of supplying gas into the airbag to inflate the airbag when the gas generator is activated.

In general, gas generators can be roughly divided into non-explosive and explosive types. In the non-explosive type gas generator, it is the mainstream to connect a sharp member such as a needle and a compressed spring to a gas cylinder filled with gas such as carbon dioxide or nitrogen, use spring force to fly the sharp member, and make the sharp member collide with a sealing plate sealing the cylinder to release the gas. At this time, a drive source such as a servomotor is usually used to release a compression force of the spring. In the case of the explosive type, either an igniter alone or an igniter and a gas generating agent may be provided. A hybrid-type or stored-type gas generator may be used in which a sealing plate in a small gas cylinder is cleaved by the power of explosives and an internal gas is discharged to the outside. In this case, a pressurized gas in the gas cylinder is selected from at least one or more non-combustible gases such as argon, helium, nitrogen and carbon dioxide. A gas generator may be equipped with an explosive heating element in order to ensure expansion when the pressurized gas is released. Furthermore, the gas generator may be equipped with a filter and an orifice for adjusting a gas flow rate as required.

(2) In the airbag device for a flying object in (1), the object to be protected mounted on the flying object is preferably a power source of the flying object, a safety device used to protect the flying object and a collision object that collides with the flying object from the impact at the time of collision, a laser surveying device capable of performing surveying, an altitude sensor capable of detecting altitude, an infrared sensor or ultrasonic sensor capable of detecting a distance from the collision object, a camera capable of performing imaging, a black box device that records acquired data, or a flight control device that controls flight of the flying object.

According to the configuration in (1) or (2), each device mounted on the flying object can be protected from the impact at the time of collision. In particular, according to the configuration in (2), since each important device mounted on the flying object can be protected from the impact at the time of collision, even after the collision, control of the flying object and operation of each device cannot be disturbed.

(3) In the airbag device for a flying object in (1) or (2), the airbag is preferably a tubular expandable body which expands so as to cover a portion (such as a side surface of a device) or the entirety of a periphery of the object to be protected mounted on the flying object when the gas generator is operated.

(4) As another aspect, in the airbag device for a flying object in (1) or (2), the airbag is preferably an expandable body having a dome-like portion which expands so as to cover a portion or the entirety of a periphery of an object to be protected mounted on the flying object when the gas generator is operated.

According to the configuration in (3) or (4), even if a device to be protected is provided outside an airframe (housing) of the flying object, the object to be protected mounted on the flying object can be protected from the impact at the time of collision.

(5) The airbag device for a flying object in (1) to (4) preferably has a vent hole capable of exhausting gas inside the airbag until the inside of the airbag reaches a predetermined internal pressure or less when the inside of the airbag reaches the predetermined internal pressure or more. When the vent hole is provided, a volume change of the gas inside the airbag at the time of collision becomes large, and there is an effect that the impact can be easily absorbed.

(6) In the airbag device for a flying object in (1) to (5), an internal pressure value of the airbag is preferably −67.4 kPa to 48.6 kPa after the internal pressure of the airbag exhibits a minimum value.

According to the configuration in (5) or (6), since the airbag suitably absorbs the impact at the time of collision, an object to be protected mounted on the flying object can be protected from the impact at the time of collision with higher accuracy.

(7) In the airbag device for a flying object in (1), preferably, one of the objects to be protected mounted on the flying object is a detection device capable of detecting or predicting collision between the flying object and an obstacle existing outside the flying object, and after the detection device detects or predicts the collision between the flying object and the obstacle existing outside the flying object, the detection device transmits an operation signal to the gas generator to operate the gas generator, and controls the airbag to start deployment within 5 ms to 36 s. Since an explosive gas generator is activated in 2 ms after receiving the operation signal, the airbag starts to be deployed in at least 5 ms after the operation signal is transmitted. Although it is possible to activate the airbag device after collision is predicted by a sensor, the longest limit in this case is 36 s.

According to the configuration in (7), the airbag can be deployed in a very short time, and, in addition, the airbag can be deployed at a suitable timing by predicting collision.

(8) In the airbag device for a flying object in (7), preferably, one of the objects to be protected mounted on the flying object is a detection device capable of detecting or predicting collision between the flying object and an obstacle existing outside the flying object, and a detectable distance from the detection device to the obstacle existing outside the flying object is 0 m to 10 m.

According to the configuration of (8), the detectable distance can be accurately detected at 0 m to 10 m of the collision by using an acceleration sensor, an ultrasonic sensor, or the like alone or by combining them. If the detectable distance exceeds approximately 10 m, it becomes difficult to judge whether or not the object collides, which will lead to an erroneous determination. In addition, an erroneous determination is led by scattering of ultrasonic waves or the like emitted from the sensor.

(9) In the airbag device for a flying object in (1), when a weight of the flying object is M [kg], a speed at which the airbag can absorb impact is W [m/s], and a numerical value X [kg^{1/2}·m/s] is M^{1/2}×W, X is preferably 50 to 900.

According to the configuration of (9), for example, when an obstacle of 10 kg collides, an impact absorption effect can be exhibited in a speed range of 16.1 to 278.9 km/h; therefore, impact can be absorbed even in collision at a maximum speed (100 km/h) of a current electric multicopter.

(10) In the airbag device for a flying object in (1) to (9), preferably, the gas generator has a pyro-type gas generating agent and is configured such that the gas is generated by combustion of the pyro-type gas generating agent to flow into the airbag.

According to the configuration of (10), a mode (generally referred to as a pyro type) in which gas generated by combustion of a pyro-type gas generating agent is made to flow into the airbag is employed, whereby as compared with a mode (generally referred to as a cylinder type) in which compressed gas filled in a container is made to flow into the airbag, the container for filling the compressed gas is not required, so that the weight of the airbag device can be further reduced.

As the pyro-type gas generating agent, a non-azide gas generating agent is preferably used, and in general, a gas generating agent is formed as a molded body containing a fuel, an oxidant and an additive. As the fuel, for example, a triazole derivative, a tetrazole derivative, a guanidine derivative, an azodicarbonamide derivative, a hydrazine derivative or the like or a combination thereof is used. Specifically, for example, nitroguanidine, guanidine nitrate, cyanoguanidine, 5-aminotetrazole and the like are suitably used. Furthermore, used as an oxidant is, for example, basic nitrate such as basic copper nitrate, perchlorate such as ammonium perchlorate and potassium perchlorate, nitrate including cation selected from alkali metal, alkaline-earth metal, transition metal, and ammonia, and the like. As the nitrate, for example, sodium nitrate, potassium nitrate and the like are suitably used. Examples of additives include a binder, a slag-forming agent, and a combustion-adjusting agent. As a binder, for example, an organic binder such as a metal salt of carboxymethyl cellulose or stearic acid salt, or an inorganic binder such as synthetic hydroxytalcite or acid clay can suitably be used. As the slag-forming agent, silicon nitride, silica, acid clay and the like can be suitably used. As the combustion-adjusting agent, metal oxides, ferrosilicon, activated carbon, graphite and the like can be suitably used. In addition, single base powder, double base powder, or triple base powder based on nitrocellulose may be used.

The shape of the molded body of the pyro-type gas generating agent includes a variety of shapes like a granule, a pellet, a columnar grain, a disk, and the like. In the molded body having a columnar shape, a perforated (for example, a single-hole cylindrical shape or a porous cylindrical shape, etc.) molded body having a through hole inside the molded body is used. In addition to the shape of the gas generating agent, it is preferable to appropriately select the size and the filling amount of the molded body in consideration of the linear burning rate, pressure index and the like of the gas generating agent.

(11) In the airbag device for a flying object in (1) to (9), the gas generator may include a gas-filled container filled with compressed gas and an igniter that has an ignition charge and cleaves the gas-filled container owing to combustion of the ignition charge to make the compressed gas as the gas flow into the airbag. Examples of a gas generator having an igniter include a hybrid-type gas generator and a stored-type gas generator.

According to the configuration of (11), a gas-filled container is cleaved by combustion of an ignition charge to flow compressed gas from the gas-filled container, so that a gas generating agent to be burned by flame due to a squib is not required.

(12) In the airbag device for a flying object in (1) to (11), preferably, at least one of the objects to be protected mounted on the flying object is provided inside an airframe (housing) of the flying object, and the airbag is provided inside the airframe of the flying object to be adjacent to the object to be protected mounted on the flying object provided inside the airframe of the flying object.

According to the configuration of (12), the airbag is provided inside the airframe of the flying object and is expandable inside the housing, whereby the weight can be significantly reduced as compared with conventional airbags that are provided at a lower portion of a flying object in an initial state and reach a region over the entire lower portion of the flying object when inflated. This does not degrade the flight performance of the flying object. Since the airbag in (11) inflates inside the airframe of the flying object provided with various devices, performance of protecting the device provided inside the flying object is satisfactorily secured. According to the above, it is possible to provide an airbag device for a flying object which is reduced in weight while sufficiently having a performance of protecting a device provided inside the flying object.

### BRIEF DESCRIPTION OF DRAWINGS

FIG. 1 is a plan view showing an airbag device for a flying object according to the present embodiment.

FIG. 2 is a plan view of a flying object equipped with the airbag device in FIG. 1, from which an upper cover member has been removed.

FIG. 3A is a cross-sectional view taken along a line A-A of FIG. 2 and including the upper cover member, and FIG. 3B is a view showing an expanded state of an expandable member of FIG. 3A.

FIG. 4 is a plan view showing an airbag device for a flying object according to a modification of the present invention.

FIG. 5A is a cross-sectional view according to a modification of FIG. 3A, and FIG. 5B is a view showing an expanded state of an expandable member of FIG. 5A.

FIG. 6A is a view showing a flying object equipped with an airbag device for a flying object according to another modification of the present embodiment, in which the airbag is in a folded position.

FIG. 6B is a view showing the flying object equipped with an airbag device of FIG. 6A, in which the airbag is in an inflated position.

FIG. 7 is a block diagram showing a functional configuration of a device mounted on the flying object of FIG. 6.

FIG. 8A is a view showing a flying object equipped with an airbag device for a flying object according to still another modification of the present embodiment, in which the airbag is in a folded position.

FIG. 8B is a view showing the flying object equipped with an airbag device of FIG. 8A, in which the airbag is in an inflated position.

FIG. 9 is a graph showing results of a tank combustion test of a gas generator used in Examples 1 and 2.

FIG. 10 is a view showing specifications of an airbag device used in Examples 1 and 2.

FIG. 11 is a table showing details of the airbag device used in Example 1. Vent0 shows an airbag device having no vent hole, Vent1 shows an airbag device having one vent hole, and Vent2 shows an airbag device having two vent holes.

FIG. 12 is a graph showing a change over time in an internal pressure (pressure) of the airbag measured in Example 1. Vent® (one-dot chain line) shows an airbag device having no vent hole, vent1 (dotted line) shows an airbag device having one vent hole, and vent2 (practice) shows an airbag device having two vent holes.

FIG. 13 is a view showing an embodiment of Example 2.

FIG. 14 is a table showing results of a resultant acceleration measurement test of Example 2.

FIG. 15 is a graph showing results of linear approximation obtained by plotting the results of the resultant acceleration measurement test of Example 2 with respect to the internal pressure of the airbag and maximum resultant acceleration. Points indicate the maximum resultant acceleration measured.

FIG. 16 is a table showing the maximum resultant acceleration in Example 2.

FIG. 17 is a graph showing results of linear approximation obtained by plotting a vent hole area percentage and the maximum resultant acceleration of the airbag device used in Example 2.

FIG. 18 is a graph in which weight of an obstacle and a relative speed of an obstacle at which impact can be absorbed by the airbag in the present invention are plotted.

FIG. 19 is an enlarged view of a section of the graph of FIG. 12.

FIGS. 20A-20F are a top view of an airbag according to one example of the present invention, in various stages of the folding process of the airbag.

### DESCRIPTION OF EMBODIMENT

Hereinafter, an airbag device for a flying object according to an embodiment of the present invention will be described with reference to the drawings.

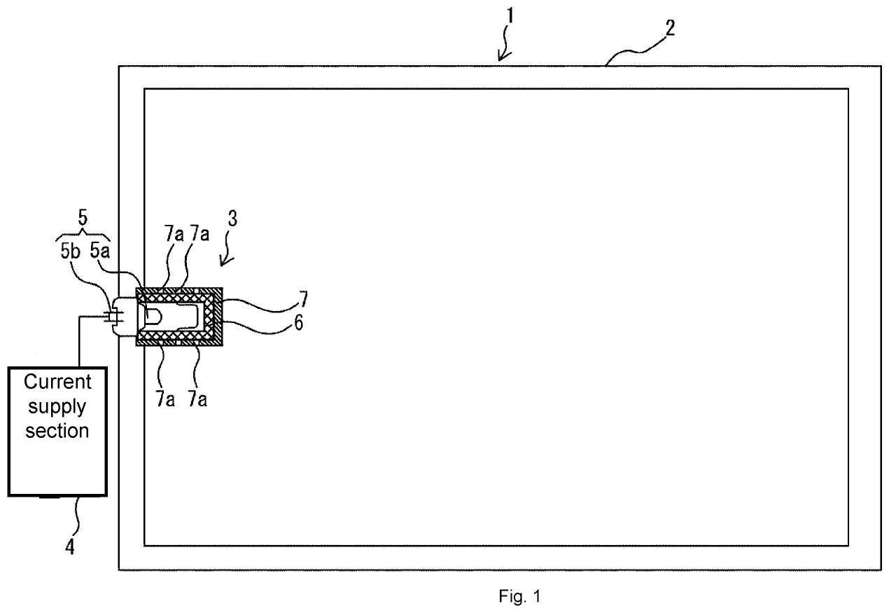

As shown in FIG. 1, an airbag device for a flying object (hereinafter, may be simply referred to as an airbag device) 1 according to the present embodiment includes an expandable member 2, a gas generator 3, and a current supply section 4. The expandable member 2 is, for example, an airbag made of cloth, polyester, or polyamide, and is configured to expand when gas flows into the inside thereof. A silicon coating may be applied to the surface of the airbag. This airbag may include one or more vent holes capable of exhausting gas inside the airbag until the inside of the airbag reaches a predetermined internal pressure or less when the inside of the airbag reaches the predetermined internal pressure or more. In FIG. 1, the expandable member 2 is formed in a rectangular shape in plan view, but is not limited to this shape. For example, the expandable member 2 may be formed in another shape such as a square shape or an elliptical shape.

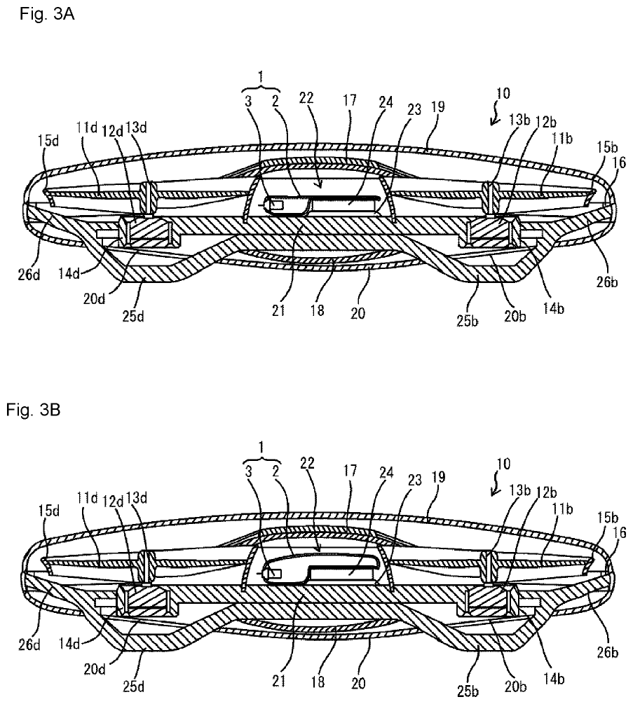

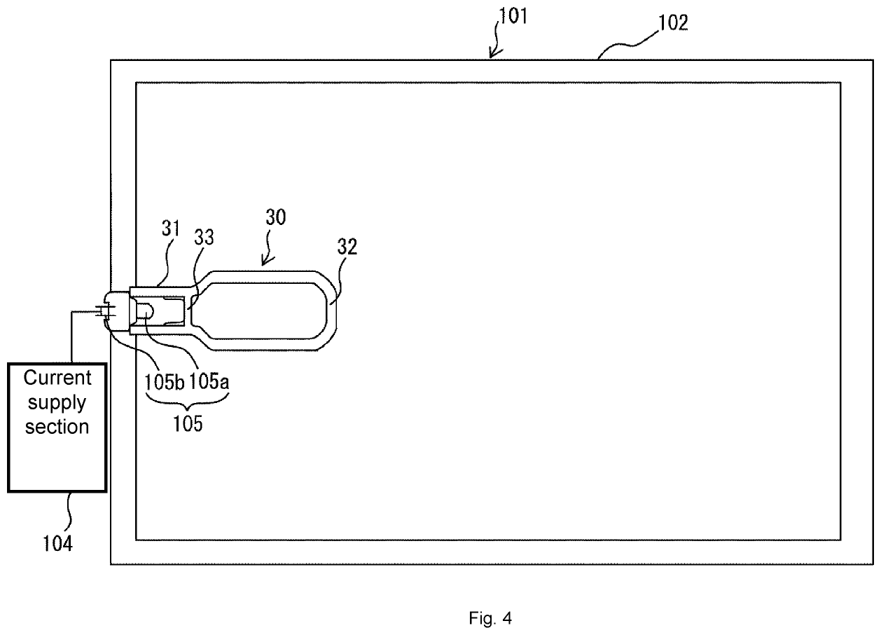

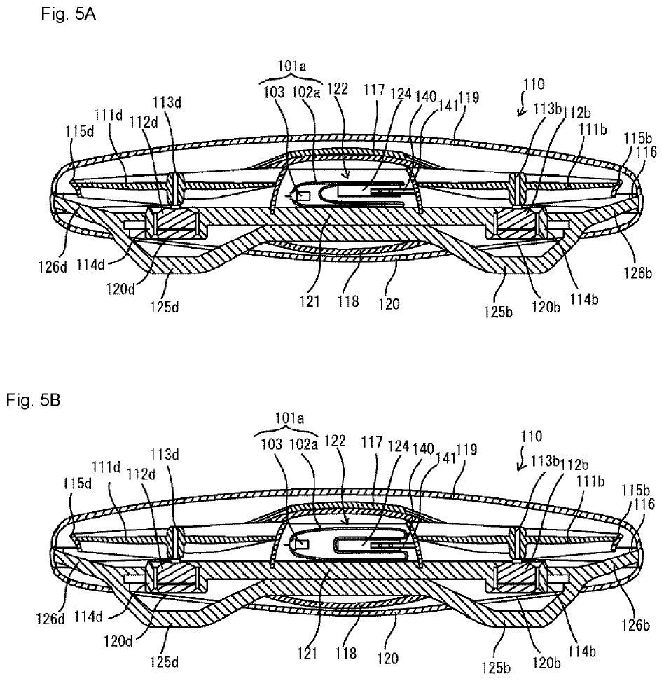

The gas generator 3 is connected to the expandable member 2. In detail, the gas generator 3 is inserted inside the expandable member 2 from a left portion of the expandable member 2 except for a portion of the gas generator 3 (refer to the below-mentioned FIGS. 3(a) and 3(b)). For this reason, although the portion of the gas generator 3 inserted inside the expandable member 2 is invisible in appearance, FIG. 1 conveniently illustrates the overall structure of the gas generator 3 in order to facilitate the understanding of the structure of the gas generator 3. The same applies to FIG. 4 and FIGS. 5(a) and 5(b) described later.

The gas generator 3 includes a squib 5, a bottomed cylindrical filter 6 having an open end, and a bottomed cylindrical gas discharge member 7 having an open end and covering an outer shape portion of the filter 6. The squib 5 has an ignition part 5a and a pair of terminal pins 5b. The ignition part 5a includes a resistor (bridge wire) (not shown) connected to the pair of terminal pins 5b, and an ignition charge is filled in the ignition part 5a so as to surround the resistor or be in contact with the resistor. A transfer charge may be charged into the ignition part 5a as necessary. A nichrome wire or the like is generally used as the resistor, and ZPP (zirconium/potassium perchlorate), ZWPP (zirconium tungsten potassium perchlorate), lead tricinate and the like are generally used as an ignition charge. The type and amount of the ignition charge can be adjusted appropriately.

The filter 6 prevents or suppresses that slag and the like are discharged out of the filter 6 during combustion of the ignition charge, and has a function of cooling gas. The filter 6 is disposed in the expandable member 2 in a state where the open end of the filter 6 is connected to an inner portion the expandable member 2. The squib 5 is disposed to close the open end of the filter 6. Although the filter 6 is provided from the viewpoint of slag collection and gas cooling as described above, from the viewpoint of reducing the weight of the airbag device 1 for a flying object and a flying object 10 described later equipped with the airbag device 1, the filter 6 is not an essential component. That is, in the present embodiment, the filter 6 may or may not be provided.

The gas discharge member 7 is disposed in the expandable member 2 in a state where the open end of the gas discharge member 7 is connected to the expandable member 2. The gas discharge member 7 has a plurality of gas outlets 7a formed on the upper side in FIG. 1, and a plurality of gas outlets 7a formed on the lower side in FIG. 1. The gas discharge member 7 is made of, for example, metal or plastic.

In such a configuration, in a state where the airbag device 1 for a flying object is mounted on the flying object, when the flying object is in a preset state such as (1) when the flying object collides, (2) when an acceleration sensor (not shown) detects acceleration not less than a value determined that the flying object is falling, or (3) when an operation signal from a wireless operation device (not shown) is not received for a certain period of time, the current supply section 4 having received a signal from a control device (not shown) (such as a computer that includes a CPU, a ROM, a RAM, and the like and operates according to a predetermined program) supplies a predetermined amount of current to the terminal pin 5b. As a result, current is supplied to the resistor in the ignition part 5a, and Joule heat is generated in the resistor, so that the ignition charge starts to burn in response to this heat. As the ignition charge burns, combustion of the pyro-type gas generating agent starts, and gas is generated in the filter 6. This gas flows into the expandable member 2 from the gas outlet 7a of the gas discharge member 7 through the filter 6. Consequently, the expandable member 2 is expanded.

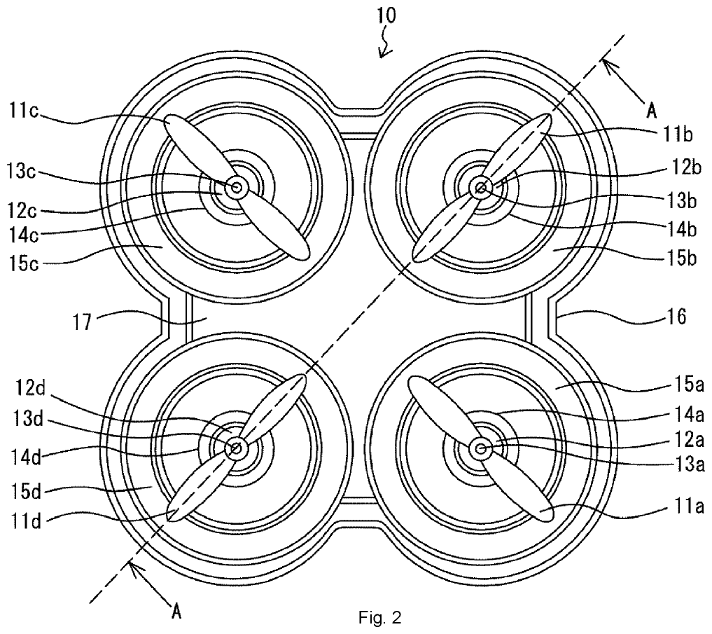

Next, the configuration of the flying object equipped with the airbag device 1 for a flying object will be described. FIG. 2 is a plan view of the flying object 10. In FIG. 2, in order to make an internal configuration of the flying object 10 easy to understand, for example, the flying object 10 is shown in a state where an upper cover member 19 (see FIGS. 3(a) and 3(b)), to be described later, which is formed of a mesh material or the like, is removed.

The flying object 10 is a flight device that performs flight based on user's remote control operation or a preset flight route. As shown in FIG. 2, the flying object 10 includes a frame 16, the upper cover member 19 (see FIGS. 3(a) and 3(b)), and a lower cover member 20 (see FIGS. 3(a) and 3(b)) formed of, for example, a mesh material or the like. The frame 16 supports the upper cover member 19 and the lower cover member 20. As shown in FIGS. 3(a) and 3(b), the upper cover member 19 covers respective components located above the frame 16. The upper cover member 19 has an upward convex rounded shape. The lower cover member 20 covers respective components located below the frame 16 except for some of the components. The lower cover member 20 has a downward convex rounded shape.

Returning to FIG. 2, the flying object 10 includes, for example, four propellers 11a, 11b, 11c, and 11d, and motors 12a, 12b, 12c, and 12d that rotationally drive the propellers 11a, 11b, 11c, and 11d correspondingly. The propellers 11a, 11b, 11c, and 11d are connected to rotary shafts 13a, 13b, 13c, and 13d of the corresponding motors 12a, 12b, 12c, and 12d. Thus, when the rotary shafts 13a, 13b, 13c and 13d are rotated by the motors 12a, 12b, 12c and 12d, the propellers 11a, 11b, 11c and 11d rotate along with the rotation. The propellers 11a, 11b, 11c and 11d are arranged at the four corners of the frame 16.

The rotational speeds of all the propellers 11a, 11b, 11c, and 11d are made the same, and while the propellers 11a and 11c are rotated in one direction, the propellers 11b and 11d are rotated in the opposite direction with respect to the one direction, whereby the flying object 10 can be raised or lowered. In a state where the flying object 10 is flying, if the rotational speed of the propellers 11a and 11b is slower than the rotational speed of the propellers 11c and 11d, the flying object 10 moves in the direction of the propellers 11a and 11b. Conversely, in the state where the flying object 10 is flying, if the rotational speed of the propellers 11c and 11d is slower than the rotational speed of the propellers 11a and 11b, the flying object 10 moves in the direction of the propellers 11c and 11d. In the state where the flying object 10 is flying, if the rotational speed of the propellers 11a and 11c is slower than the rotational speed of the propellers 11b and 11d, the flying object 10 horizontally rotates clockwise or counterclockwise. Thus, the flying object 10 can realize each operation of floating, horizontal movement, rotational movement, stopping, and landing by changing the rotational speed and rotational direction of the propellers 11a, 11b, 11c, and 11d. The number of propellers is a mere example and is not limited to four.

Subsequently, the flying object 10 includes rotor guards 15a, 15b, 15c, and 15d that correspondingly protect the propellers 11a, 11b, 11c, and 11d, and an upper center guard 17 and a lower center guard 18 connected to each other (see FIGS. 3(a) and 3(b)). The rotor guards 15a, 15b, 15c, and 15d, the upper center guard 17, and the lower center guard 18 are formed of, for example, resin or the like. The rotor guards 15a, 15b, 15c, and 15d are annular members provided so as to surround rotation regions of the corresponding propellers 11a, 11b, 11c, and 11d. The rotor guards 15a, 15b, 15c, and 15d thus configured can protect the propellers 11a, 11b, 11c, and 11d from horizontal impacts on the flying object 10.

As shown in FIGS. 3(a) and 3(b), an internal space 22 is formed by the upper center guard 17 and a central frame 21 described later. In the internal space 22, a battery 24 supported by a base 23 and the above-described airbag device 1 which protects the battery 24 are disposed. Thus, the battery 24 is protected by the upper center guard 17 and the central frame 21 at the time of impact, and also by the inflated expandable member 2 of the airbag device 1. For example, a lithium ion battery can be employed as the battery 24.

Subsequently, the flying object 10 is provided with various components for retaining the structure of the flying object 10. More specifically, as shown in FIGS. 3(a) and 3(b), the flying object 10 has legs 25b and 25d located below the propellers 11b and 11d, frame connecting members 26b and 26d, the central frame 21, and motor holding portions 14b and 14d. Although not shown, legs, frame connecting members, motor holding portions, and openings described later are provided corresponding to the propellers 11a and 11c.

The legs 25b and 25d are grounded when the flying object 10 lands. Here, in the lower cover member 20, openings 20b and 20d are formed in portions corresponding to the legs 25b and 25d. The leg 25b protrudes outward through the opening 20b, and the leg 25d protrudes outward through the opening 20d. The opening 20b is formed below the propeller 11b, and the opening 20d is formed below the propeller 11d, whereby air permeability below the propellers 11b and 11d is improved, so that the flight performance can be improved.

The frame connecting member 26b is connected to the frame 16, the leg 25b, and the central frame 21, and the frame connecting member 26d is connected to the frame 16, the leg 25d, and the central frame 21. The frame connecting members 26b and 26d are members having elasticity, and are formed of, for example, plastic. Thus, by making the frame connecting members 26b and 26d elastic, it is possible to absorb the impact from the frame 16 and the four legs including the legs 25b and 25d.

The central frame 21 is provided substantially at the center in the height direction inside the flying object 10. The central frame 21 is formed of, for example, a member that is strong and is less likely to be thermally deformed like metals, carbon, or the like. The base 23 described above and a portion of the expandable member 2 of the airbag device 1 are disposed on the central frame 21. The motor holding portions 14b and 14d hold the motors 12b and 12d. The motor holding portions 14b and 14d are supported by the central frame 21.

Here, as shown in FIG. 3(a), in an initial state, that is, in a state where no collision has occurred, a portion of the expandable member 2 is disposed in contact with an upper portion of the battery 24. In this case, it is desirable that a portion of the expandable member 2 be disposed in contact with the entire upper portion of the battery 24 from the viewpoint of reliability of the protection of the battery 24.

Based on the state of FIG. 3(a), when it is determined by a control device (not shown) that the flying object 10 is in a preset state such as when the flying object 10 collides due to falling or the like, as shown in FIG. 3(b), gas flows into the expandable member 2 to expand the expandable member 2. Thus, when the expandable member 2 is in an expanded state, a portion of the expandable member 2 is in contact with the entire upper portion of the battery 24. Thereby, at the time of collision, the impact on the battery 24 can be sufficiently absorbed.

As described above, according to the airbag device 1 according to the present embodiment, the expandable member 2 is provided inside an airframe (housing (the upper cover member 19 and the lower cover member 20)) of the flying object 10 provided with the battery 24 and is expandable inside the airframe, whereby the weight can be significantly reduced as compared with conventional airbags that is provided at a lower portion of a flying object in an initial state and reaches a region over the entire lower portion of the flying object when inflated. This does not degrade the flight performance of the flying object 10. Since the expandable member 2 expands inside the airframe of the flying object 10 provided with the battery 24, performance of protecting the battery 24 is satisfactorily secured. According to the above, it is possible to provide the airbag device 1 for a flying object which is reduced in weight while sufficiently having a performance of protecting the battery 24.

In the present embodiment, a mode (pyro type) in which gas generated by combustion of the ignition charge is made to flow into the expandable member 2 is employed, whereby as compared with a mode (cylinder type) in which compressed gas filled in a container is made to flow into an expandable member, the container for filling the compressed gas is not required, so that the weight of the airbag device 1 can be further reduced.

In the present embodiment, a portion of the expandable member 2 is disposed in contact with the upper portion of the battery 24 in the initial state, whereby the upper portion of the battery 24 can be satisfactorily protected when the expandable member 2 is expanded.

Thus, the embodiment of the present invention has been described hereinabove with reference to the drawings. However, the specific structure of the present invention shall not be interpreted as to be limited to the above described embodiment. The scope of the present invention is defined not by the above embodiment but by claims set forth below, and shall encompass the equivalents in the meaning of the claims and every modification within the scope of the claims. The following modifications can be applied.

In the above embodiment, the mode (pyro type) in which gas generated by combustion of a powder is made to flow into the expandable member 2 is employed, but the invention is not limited thereto, and, as described below, the cylinder type in which compressed gas filled in a gas-filled container is made to flow into an expandable member 102 may be employed. Here, in the following description, components with the same last two digits as those in the above-described embodiment are the same as those described in the above-described embodiment unless otherwise specified, and therefore the description thereof may be omitted.

As shown in FIG. 4, a gas generator 30 according to the modification includes a squib 105, a connection chamber 31 disposed in the expandable member 102 in a state where an open end of the connection chamber 31 is connected to an inner portion of the expandable member 102, a gas-filled container 32 filled with compressed gas and disposed inside the expandable member 102, and a vulnerable wall 33 partitioning the connection chamber 31 and the gas-filled container 32. A portion of the gas-filled container 32 is a vulnerable portion. The open end of the connection chamber 31 is closed by the squib 105.

In the configuration as described above, in a state where an airbag device 101 for a flying object is mounted instead of the airbag device 1 for the flying object 10 of the above embodiment, at the time of collision, a current supply section 104 having received a signal from a control device (not shown) supplies a predetermined amount of current to a terminal pin 105b. As in the above embodiment, current is supplied to the resistor in an ignition part 105a, and Joule heat is generated in the resistor, so that the ignition charge starts to burn in response to this heat.

Then, the ignition charge burns to generate gas in the connection chamber 31. The pressure of the gas causes the vulnerable wall 33 to be cleaved, and as a result, the pressure in the gas-filled container 32 increases, so that the vulnerable portion of the gas-filled container 32 is cleaved. As a result, the compressed gas in the gas-filled container 32 flows into the expandable member 102, and the expandable member 102 is expanded. According to such an embodiment, the gas generating agent burned by flame due to the squib 105 is not required.

In the above embodiment, a portion of the expandable member 2 is disposed in contact with the upper portion of the battery 24 in the initial state, but the invention is not limited thereto, and as long as the battery 24 can be protected after operation, a portion of the expandable member 2 may be disposed separately above the battery 24 without being in direct contact with the upper portion of the battery 24 in the initial state. A portion of the expandable member 2 may be disposed in contact with a side portion of the battery 24 in the initial state, or may be disposed to the side of the battery 24.

Furthermore, in the above embodiment, a portion of the expandable member 2 is disposed in contact with the upper portion of the battery 24 in the initial state, but the invention is not limited thereto, and as shown in FIG. 5(a), an expandable member 102a may be disposed so as to surround the upper portion of a battery 124, at least one side portion and a lower portion of the battery 124 in the initial state. In this case, the battery 124 is supported by a horizontally extending plate member 140 which is fixed to a wall portion 141 provided in an internal space 122 at one side thereof. According to such a configuration, as shown in FIG. 5(b), when the expandable member 102a is expanded, the expandable member 102a can protect the upper portion, at least one side portion and the lower portion of the battery 124.

In the above embodiment and modification, although protection of the battery provided inside the airframe of the flying object has been explained, the present invention can be applied not only to the battery but any device provided inside the airframe.

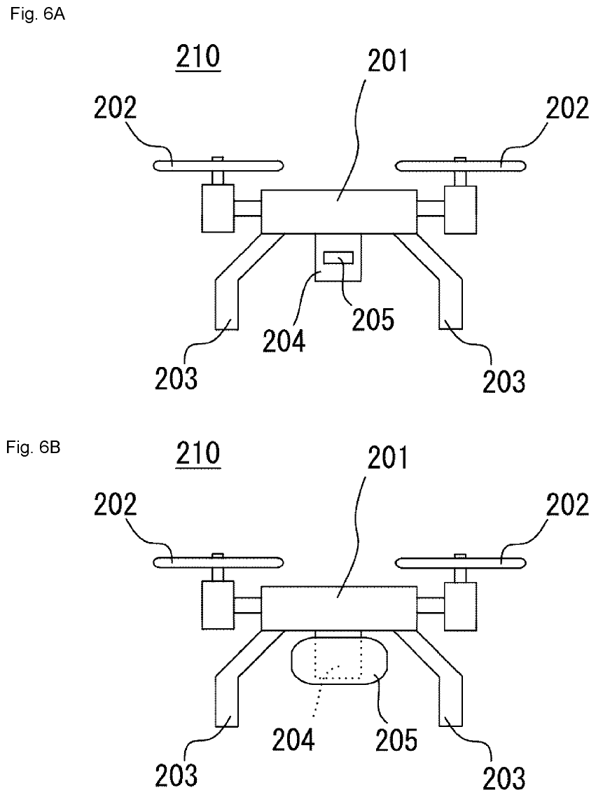

Further, as another modification, there are an airbag device for a flying object according to a modification shown in FIG. 6 and a flying object provided with the airbag device. This will be described in detail below.

A flying object 200 includes an airframe 201, one or more propulsion mechanisms (such as a propeller) 202 that are connected to the airframe 201 and propel the airframe 201, a plurality of legs 203 provided at a lower portion of the airframe 201, a device 204 provided at a lower center of the airframe 201, and an airbag device 205 provided on a side surface of the device 204. Although the airbag device 205 has substantially the same configuration as any of the airbag devices in the above embodiment or the modification, the airbag device 205 is different in that as shown in FIG. 6(A), the shape is contracted or folded before inflation of an airbag (initial state) and, as shown in FIG. 6(B), the shape is tubular after inflation of the airbag. A plurality of the airbag devices 205 may be provided so as to cover all the side surfaces of the device 204, or the airbag device 205 may be provided in a ring shape so as to cover all the side surfaces of the device 204 with one airbag. Although the airbag has a tubular shape in this modification, the present invention is not limited thereto, and one or more spherical or oblate spherical airbags may be provided on the side surface of the device 204 and/or a bottom surface of the device 204.

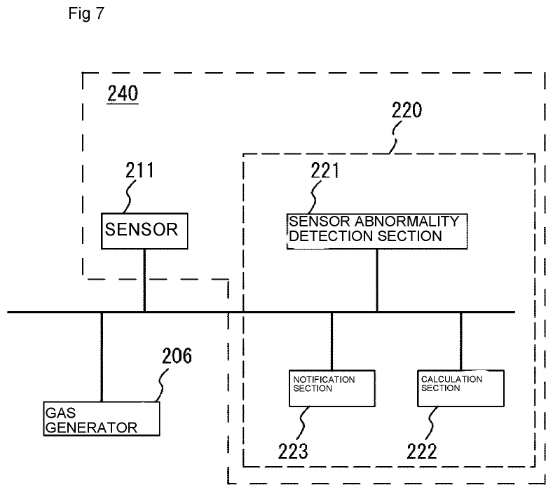

The device 204 is, for example, a power source of the flying object 200, a safety device used to protect the flying object 200 and a collision object that collides with the flying object 200 from the impact at the time of collision, a laser surveying device capable of performing surveying, an altitude sensor capable of detecting altitude, an infrared sensor or ultrasonic sensor capable of detecting a distance from the collision object, a camera capable of performing imaging, a controller 220 (see FIG. 7), a black box device (data recording device) that records acquired data, or a flight control device (such as a flight controller) that controls flight of the flying object 200, but the device 204 is not limited thereto. Here, examples of the safety device include a parachute, a paraglider, and an ejection device that ejects a parachute or paraglider. The controller 220 is also a part that constitutes a portion of an abnormality detection device (detection device) 240.

As shown in FIG. 7, the abnormality detection device 240 includes a sensor (detection part) 211 and a controller (computer having a CPU, a ROM, a RAM, and the like) 220 and is electrically connected to an igniter (not shown in FIG. 6A) in a gas generator 206 of the airbag device 205.

The sensor 211 detects a flight state of the flying object 200 (including collision, collision prediction, crash, and the like). Specifically, the sensor 211 is a sensor including one or more selected from, for example, an acceleration sensor, a gyro sensor, an air pressure sensor, a laser sensor, an ultrasonic sensor, etc. and can acquire data of the flying state of the flying object 200, such as the speed, acceleration, inclination, altitude, and position of the flying object 200.

The controller 220 includes a sensor abnormality detection section 221, a calculation section 222, and a notification section 223 as a functional configuration. The controller 220 executes a predetermined program to functionally realize the sensor abnormality detection section 221, the calculation section 222, and the notification section 223.

The sensor abnormality detection section 221 detects an abnormal state of the sensor 211. That is, the sensor abnormality detection section 221 detects whether the sensor 211 can operate normally.

The calculation section 222 determines whether the flying state of the flying object is abnormal, specifically, whether the flying object 200 has received an impact (or whether the flying object 200 has collided), based on each piece of data acquired by actual measurement by the sensor 211. Alternatively, the calculation section 222 predicts that the flying object 200 collides with an external obstacle (collision prediction). In the collision prediction, a distance between the flying object 200 and an obstacle is measured by an infrared sensor, an ultrasonic sensor, or the like, and a relative speed between the flying object 200 and the obstacle is measured by an acceleration sensor, a camera, or the like. Alternatively, the calculation section 222 calculates the relative speed with respect to the obstacle from a time change of the measured distance and calculates time until collision from the relative speed of the obstacle and the distance from the obstacle at that time. When the calculation result is equal to or more than a predetermined threshold value, a collision is predicted, and it is determined that the flight state is abnormal. When the calculation section 222 determines that the flight state of the flying object is abnormal or predicts that the flying object 200 collides with an external obstacle, the calculation section 222 outputs an abnormality signal (that may include an instruction signal to activate or operate other equipment) to the outside; however, an abnormality signal output section may be provided separately from the calculation section 222 and output the abnormality signal according to an instruction of the calculation section 222.

When the sensor abnormality detection section 221 detects an abnormality in the sensor 211, the notification section 223 notifies an administrator or the like that the abnormality has been detected.

Subsequently, the operation of the abnormality detection device 240 of the present embodiment will be described.

First, the sensor abnormality detection section 221 performs an abnormality inspection of the sensor 211. Specifically, whether an acceleration sensor or the like that measures the acceleration of the flying object normally operates is inspected by the sensor abnormality detection section 221.

When it is not determined that there is no abnormality as a result of the above inspection, the sensor abnormality detection section 221 notifies the administrator or the like of an error and ends the inspection. On the other hand, when it is determined that there is no abnormality as a result of the inspection, the calculation section 222 reads each piece of data actually measured by the sensor 211.

When the data measured and acquired by the sensor 211 is not abnormal (including a case where the collision prediction is determined), the calculation section 222 outputs a signal to be returned to the processing of the abnormality inspection of the sensor 211 by the sensor abnormality detection section 221.

On the other hand, when the acquired data is abnormal (including the case where the collision prediction is determined), the calculation section 222 outputs the abnormal signal to the gas generator 206. When the collision prediction is determined, the abnormality signal is immediately output to the gas generator 206 if a prediction time until collision is shorter than time required to deploy the airbag, and if the prediction time until the collision is longer than the time required to deploy the airbag, a sum of time to reach an optimal internal pressure value of the airbag and the time required to deploy the airbag is compared with the calculated time until the collision. If the calculated time is shorter, the abnormality signal is output to the gas generator 206, and if the calculated time is longer, the process of measuring the distance from the obstacle again and calculating the time until the collision again is repeated. By following this process, malfunction or erroneous detection is prevented to ensure reliability of the operation.

Then, the gas generator 206 having received a deployment device activation signal is activated, deploys the airbag of the airbag device 205 such that the airbag has a shape as shown in FIG. 6(B), and ends the process.

According to the present modification configured as above, since each important device mounted on the flying object 200 can be protected from the impact at the time of collision, even after the collision, control of the flying object 200 and operation of each device cannot be disturbed. In particular, a device provided outside the flying object 200 can be effectively protected from the impact at the time of collision.

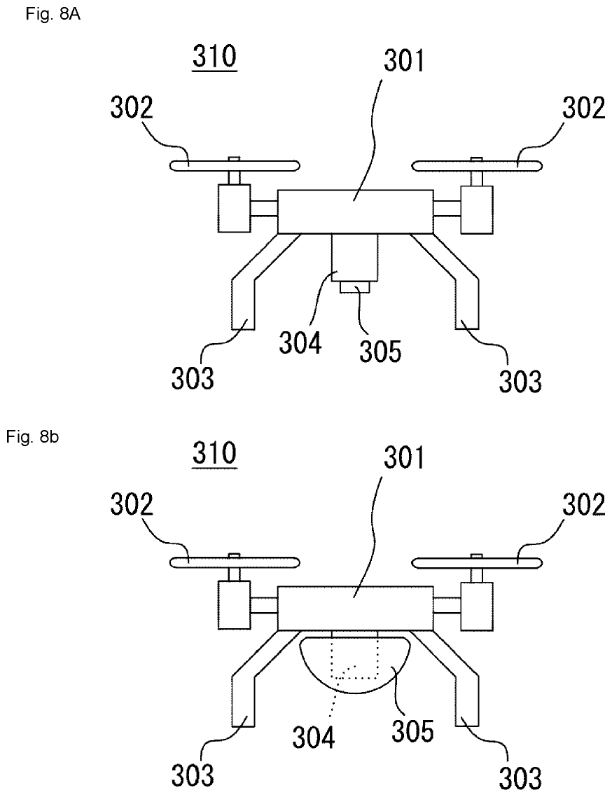

Further, as another modification, there are an airbag device 305 for a flying object according to a modification shown in FIG. 8 and a flying object 300 provided with the airbag device 305. This will be described in detail below. In the present modification, components with the same last two digits as those in the modification shown in FIG. 6 are the same as those described in the modification shown in FIG. 6, and therefore the description thereof may be omitted.

The present modification is different from the modification shown in FIG. 6 only in that the airbag device 305 is provided at a lower portion of the device 304 (see FIG. 8(A)) and the deployed airbag has a dome shape to cover a periphery (side surface and lower surface) of the device 304 (see FIG. 8(B)), and the other points are substantially the same including the action and the effect.

A detectable distance can be accurately detected at 0 m to 10 m of the collision by using an acceleration sensor, an ultrasonic sensor, or the like alone or by combining them. If the detectable distance exceeds approximately 10 m, it becomes difficult to judge whether or not the object collides, which will lead to an erroneous determination. In addition, an erroneous determination is led by scattering of ultrasonic waves or the like emitted from the sensor.

In the present invention, a tank combustion test is a test conducted by the method described below. A gas generator for an airbag is fixed at room temperature in a 60-liter SUS (stainless steel) tank, and a cable sealed from the outside of the tank to the inside of the tank is connected to an igniter of the gas generator to seal the tank. Further, the sealing cable is connected to an outside ignition current generating device. The ignition current generating device is switched on, and the switching-on operation is used as a trigger to start data collection by a pressure sensor installed on an inner wall of the tank. The time when the ignition current generating device is switched on is set to 0, and a pressure increase change in the tank is measured by a data logger for time from 0 ms to 210 ms. A sampling rate is 10 kHz. Data sampled by the data logger is digitally signal processed to obtain a curve that finally serves as a tank pressure-time (kPa/milliseconds) curve and evaluates performance of the gas generator.

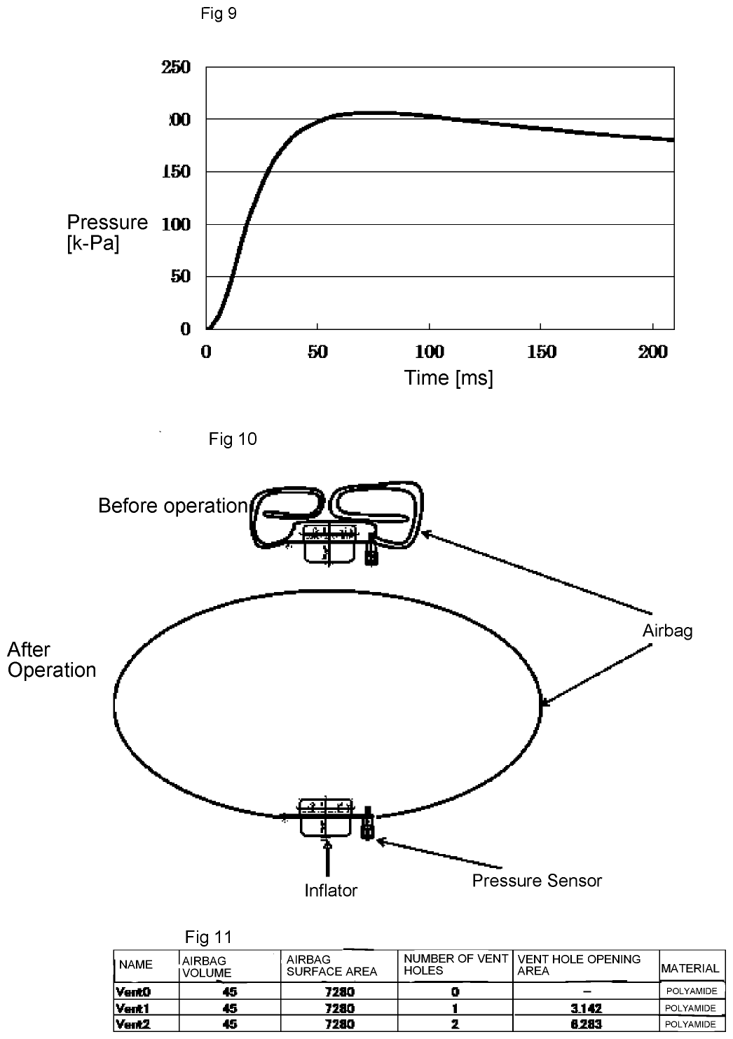

The tank combustion test was conducted on the gas generators used in Examples 1 and 2. The results are shown in FIG. 9.

Specifications of the airbag used in Examples 1 and 2 are shown in FIG. 10.

### Example 1

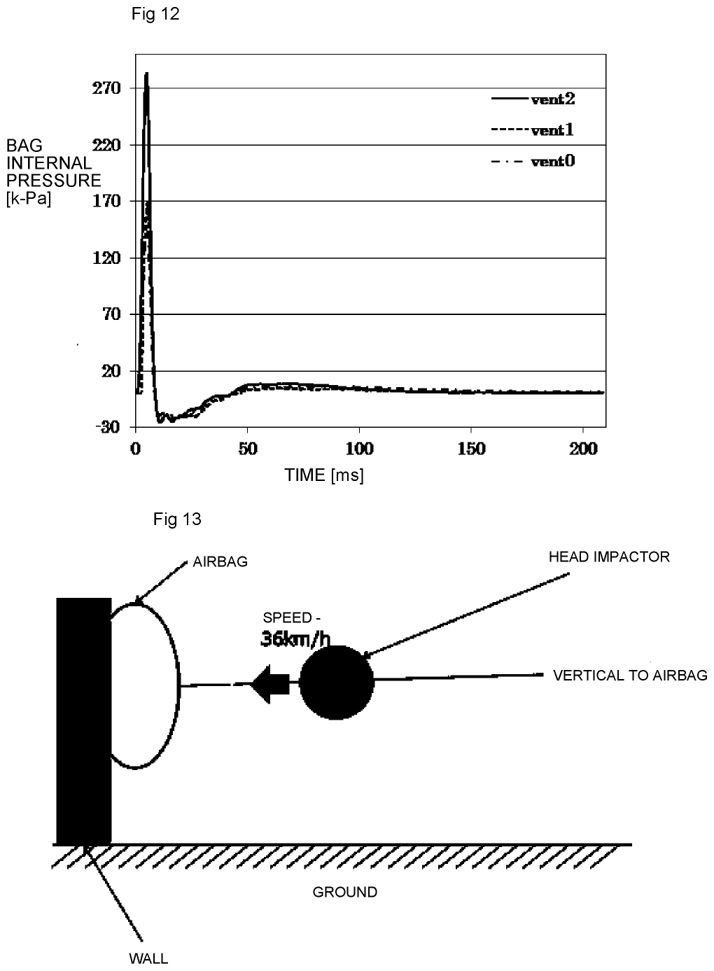

A device (airbag device) in which a gas generator was assembled to the above-described airbag folded into a small size was used, a pressure sensor (PGM-10KC (Kyowa Electronic Instruments Co., Ltd.)) was attached to the airbag device in an initial state, and the airbag device was operated. The result of measuring a change over time in an internal pressure (pressure) of the airbag is shown in FIG. 11. As the airbag device, one having two vent holes, one having one vent hole, and one having no vent holes were used. The results are shown in FIG. 12.

In FIG. 12, a maximum value and a minimum value appear in the range of 0 ms to 10 ms. The maximum value is due to an operating pressure of the gas generator, since a gap between the gas generator and the bag was very small in the state where the bag was folded into a small size. Subsequently, a volume change occurred as the airbag inflated, and the pressure dropped rapidly to reach the minimum value. Since the airbag itself was not deployed during this time, the function of the airbag was not exercised, so that an accurate internal pressure value of the airbag was not indicated.

### Example 2

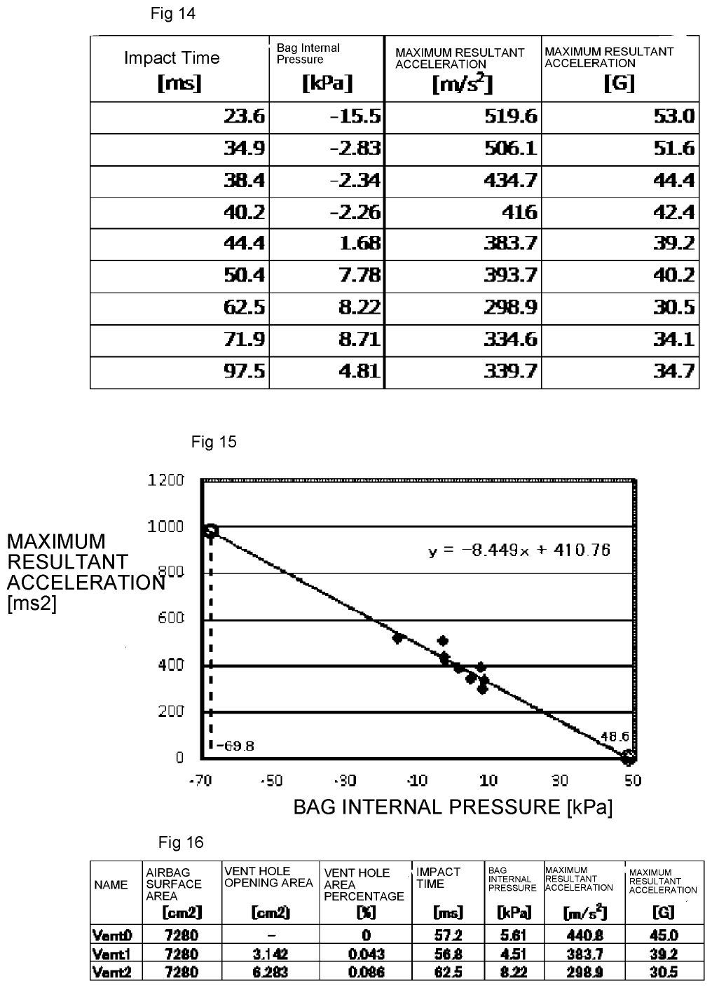

Using the same airbag device having two vent holes as used in Example 1, a resultant acceleration calculation test was conducted by an impactor test in which using the facilities of Japan Automobile Research Institute, a head impactor (comparable product with domestic technical standard and ECE No. 127) was vertically collided with the airbag at 36 km/h. The outline of this test is shown in FIG. 13. Since the same airbag device as that of Example 1 was used, the internal pressure of the airbag at a predetermined time was the same as in Example 1, and the impactor was made to collide for nine predetermined times (nine predetermined internal pressures) to measure resultant acceleration. A peak top value of the measured resultant acceleration is taken as maximum resultant acceleration, and the result is shown in FIG. 14.

FIG. 15 shows results of linear approximation obtained by plotting the result of FIG. 14 with respect to the internal pressure of the airbag and the maximum resultant acceleration. According to a continuous impact test JIS C 60068-2-27, an indication of the maximum resultant acceleration at which the device is protected is set to peak acceleration 1000 m/s² or less, and from the above approximate straight line, it is considered that an airbag internal pressure suitable for protection (=the airbag internal pressure after an internal pressure of the airbag exhibits a minimum value) is −69.8 kPa to 48.6 kPa.

### Example 3

A resultant acceleration measurement test according to an impactor test was conducted in the same manner as in (Example 2) using each of the airbag devices of (Example 1). The resultant acceleration was measured at each time (60 ms) at when the maximum resultant acceleration decreased in (Example 2). A peak top value of the measured resultant acceleration is taken as the maximum resultant acceleration, and the result is shown in FIG. 16. In the airbag having no vent hole, a vent hole area percentage was set to 0.

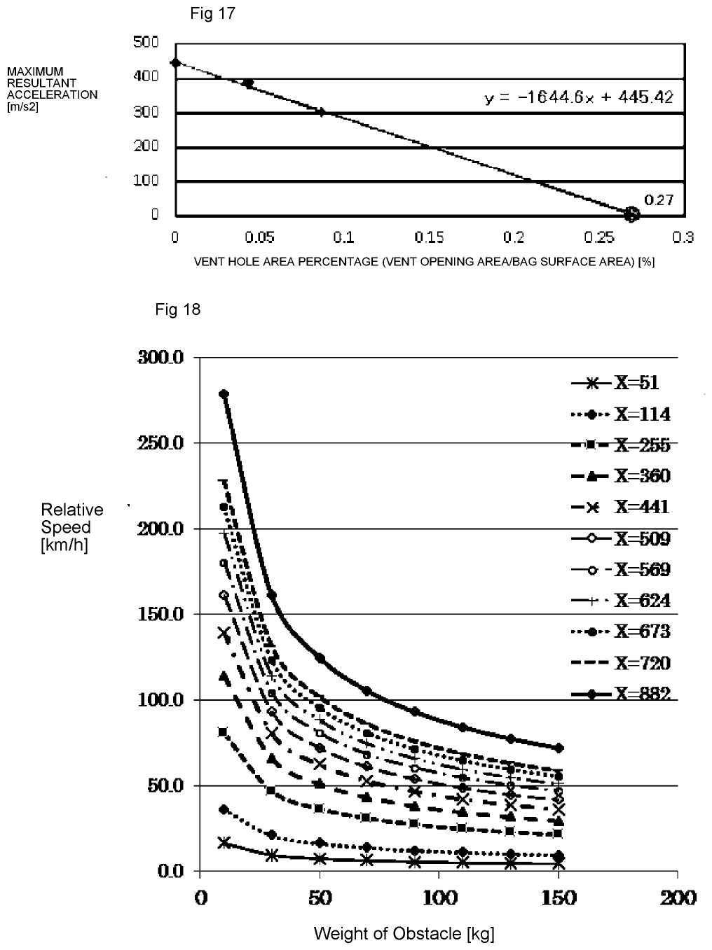

FIG. 17 shows results of linear approximation obtained by plotting the result of FIG. 16 with respect to the vent hole area percentage and the maximum resultant acceleration. From the above approximate straight line, it can be seen that the higher the vent hole area percentage, the lower the maximum resultant acceleration, and the vent hole area percentage at which the maximum resultant acceleration becomes 0 is 0.27%. Thus, the area percentage of the vent hole suitable for protection is considered to be 0% to 0.27%.

### Example 4

Using the airbag device of the present invention, an estimate was made that an obstacle having a weight of M [kg] was made to collide. The trial calculation was performed according to the procedure shown below.

(1) Calculation of Theoretical Energy Absorption Value of Airbag

A theoretical energy absorption value P×V [J] of the airbag is obtained from an airbag internal pressure P [kPa] and an airbag volume V [L] when an obstacle collides.

(2) Calculation of Speed W at which Impact can be Absorbed by Airbag

A relative speed W [km/h] of an obstacle (weight M [kg]) at which impact can be absorbed by the airbag is expressed by the following equations according to the energy conservation law.

$$P \times V = \frac{1}{2} {M ( \frac{W}{3.6} )}^{2} ∴ W = 5.1 \times \sqrt{\frac{PV}{M}}$$

(3) Calculation of Numerical Value X

A numerical value X [(kg)^{1/2}.km/h] is defined as the following equation.

FIG. 18 shows results of trial calculations in the range of the internal pressure P (10 to 50 kPa) and the bag volume (10 to 600 L) of an airbag that can be implemented in the present invention.

From FIG. 18, it was found that the airbag of the present invention had a numerical value X in the range of 50 to 900.

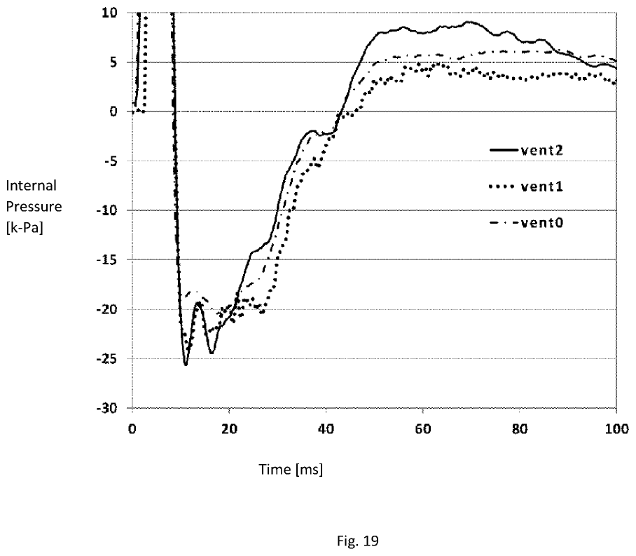

Referring to FIG. 19, which is an enlarged section of the graph of FIG. 12. As shown the internal pressure of the airbag can be configured to form internal negative pressure. This can be done at the initial stage of the airbag deployment. As shown in FIG. 19, at the very initial period 0-10 ms there is a very strong positive pressure. The pressure then drops sharply such that at 10 ms the pressure becomes negative, with respect to the atmosphere. The initial swift positive pressure is caused by the sudden gas supply into the airbag. As a result of this sudden gas supply the airbag is urged to its unfolded position, which leads to an increase in the internal volume of the airbag. Consequently, the increased volume causes the internal pressure to sharply decrease until it reaches the negative pressure. At this stage the vent holes allow intake of outside air, until the internal pressure is positive. It is noted that while the pressure inside is negative, the gas is continuously sent from the gas generator to the inside airbag. Therefore, the pressure inside the bag rises again due to the intake of outside air from the vent hole and the gas sent from the gas generator.

As shown in FIG. 19, around Time 0 to 20 ms when the gas generator is activated, the cloth of the airbag is pushed forward to start the airbag deployment. At this time, since the airbag is deployed by gas inertia, and not by the gas pressure, the gas supply cannot keep up with the sudden increase of the bag volume, and the internal pressure of the airbag becomes negative. This deployment by gas inertia is possible since the airbag is folded in such a way that the deployment of the airbag at this initial state is urged by the gas inertia caused by sudden push of gas into the airbag.

Around Time 20 to 50 ms in FIG. 19, after the deployment of the airbag caused by the gas inertia, the gas supply keeps up with the deployment, and then the internal pressure of the airbag turns into positive pressure. In other words, after the bag deployment due to gas inertia, the bag is unfolded and the gas supply catches up and the internal pressure of the bag goes toward positive pressure.

According to an example, the airbag is configured for a folded position and an unfolded position. In the folded position, the vent hole is covered by portions of the folded airbag, such that the vent hole is not exposed to the outside. This way, at the initial state the vent hole is blocked from air intake.

Due to the sudden gas inertia the airbag is urged to deploy to its unfolded position, such that the vent hole is no longer blocked by portions of the airbag. Consequently, once the airbag is unfolded, the vent hole allows air into the bag. It is noted that such air intake is urged by the internal negative pressure caused by the swift unfolding of the airbag. Accordingly, the vent hole is provided at a location in which at the folded position of the airbag the vent hole is blocked and at the unfolded position the vent hole is exposed.

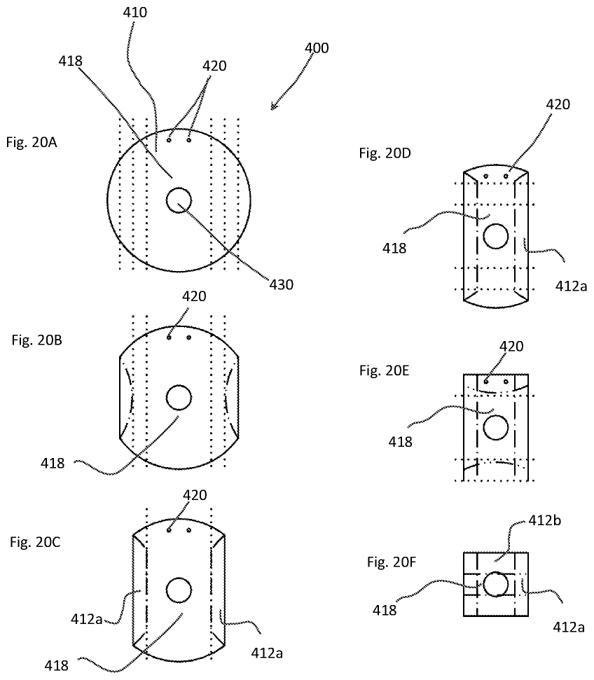

As shown in FIGS. 20A-20F, the airbag 400 can include a flexible foldable body 410 having one or more vent holes 420 and a central aperture 430 which is coupled to an inflator (not shown). The folding steps of the airbag 400 are illustrated in the order of FIGS. 20A to 20F. The dotted lines in the figures are creases, which are configured such that when the airbag is folded all creases are rolled up on the back side of the drawing. As shown in the figures, the foldable body 410, includes folded portions 412a and 412b, here illustrated as the sides of the foldable body, and an unfolded portion 418, which includes the central aperture 430. The vent holes 420 are positioned on the folded portions 412b, such that in the folded position, of FIG. 20F, the vent holes 420 are covered by the folded portions 412b. The central aperture 430 on the other hand, is exposed, allowing gas to be pushed into the airbag even at the folded position.

It is noted that according to the illustrated example, the vent holes are located on the second folded portions 412b, such that in the folded position, the first folded portions 412a do not cover the vent holes 420. The second folded portions 412b are folded on top of the first folded portions 412a. This way, when the airbag is urged to be deployed, the second folded portions 412b are unfolded first, and only then the first folded portions 412a are unfolded. As a result, as soon as the second folded portions 412b are unfolded the vent holes 420 are uncovered allowing air intake.

It would be appreciated that according to another example the vent holes 420 can be located on the first folded portions 412a. This way, the vent holes 420 are not exposed until the second folded portions 412b and the first folded portions 412a are unfolded. Thus, the air intake is delayed, and duration of the internal negative pressure is extended. Thus, the position of the vent holes 420 determines the time duration during which the internal pressure in the bag is negative.

Furthermore, according to other examples, instead of the roll-shaped folding of rolling up, bellows-shaped folding may be used, or the roll-shaped folding and the bellows-shaped folding may be combined. Moreover, the vent hole is preferably as far away from an inflator as possible.

Accordingly, when gas is generated in the initial state, the airbag 400 is in its folded position (FIG. 20F). After the internal pressure of the airbag increases and reaches the upper limit peak, the internal pressure of the airbag sharply decreases during the deployment of the airbag. This is since the pressure of the generated gas is converted into the deployment force of the airbag.

Furthermore, in this initial state of the airbag the first and second folded portions 412a and 412b are joined together, and overlapped such that vent holes 420 are blocked by one of the first and second folded portions 412a and 412b. Thus, gas does not flow in or out through the vent holes. After the sharp increase of the internal pressure the first and second folded portions 412a and 412b are separated from each other.

In this regard, when the airbag device is activated, in the middle of the deployment after the initial state of the folded airbag shown in FIG. 20F, the first and second folded portions 412a and 412b are forcibly pulled apart so as to be suddenly blown away by the force of the generated gas without causing any harm to an object.

In this way, the increase in internal volume of the airbag is caused primary by the gas inertia, i.e., the forces acting on the gas, rather than the effect of the generated gas filling the inside of the bag. Thus, when the internal volume of the airbag is increased at about 10 ms, the pressure inside the airbag becomes negative.

Then, while the airbag is under negative pressure, outside air flows in from the vent hole 420, and at the same time the gas generator provides gas into the airbag. Such two effects make the inner pressure rise. From the fact mentioned above, it can be understood that at about 10 ms, the effect of the generated gas is smaller than the effect of forcibly and suddenly separating the two pieces of cloth so as to be blown off.

REFERENCE SIGNS LIST

| 1, 101, 101a, 205, 305 | Airbag device for flying object |
|---|---|
| 2, 102, 102a | Expandable member |
| 3, 30, 103, 206 | Gas generator |
| 4, 104 | Current supply section |
| 5, 105 | Squib (igniter) |
| 5a, 105a | Ignition part |
| 5b, 105b | Terminal pin |
| 6 | Filter |
| 7 | Gas discharge member |
| 7a | Gas outlet |
| 10, 110 | Flying object |
| 11a, 11b, 11c, 11d, 111b, 111d | Propeller |
| 12a, 12b, 12c, 12d, 112b, 112d | Motor |
| 13a, 13b, 13c, 13d, 113b, 113d | Rotary shaft |
| 14a, 14b, 14c, 14d, 114b, 114d | Motor holding portion |
| 15a, 15b, 15c, 15d, 115b, 115d | Rotor guard |
| 16, 116 | Frame |
| 17, 117 | Upper center guard |
| 18, 118 | Lower center guard |
| 19, 119 | Upper cover member (housing) |
| 20, 120 | Lower cover member (housing) |
| 20b, 20d, 120b, 120d | Opening |
| 21, 121 | Central frame |
| 22, 122 | Internal space |
| 23 | Base |
| 24, 124 | Battery |
| 25b, 25d, 125b, 125d, 203, 303 | Leg |
| 26b, 26d, 126b, 126d | Frame connecting member |
| 31 | Connection chamber |
| 32 | Gas-filled container |
| 33 | Vulnerable wall |
| 140 | Plate member |
| 141 | Wall portion |
| 201, 301 | Airframe |
| 202, 302 | Propulsion mechanism |
| 204, 304 | Object to be protected mounted on |
| | flying object |
| 211 | Sensor |
| 220 | Controller |
| 221 | Sensor abnormality detection section |
| 222 | Calculation section |
| 223 | Notification section |
| 240 | Abnormality detection device |

1. An airbag device for a flying object, which protects at least one of objects to be protected mounted on the flying object, the airbag device comprising:
an airbag which is provided adjacent to at least one of the objects to be protected mounted on the flying object, said airbag is selectively shifted between a folded position and a deployed position, such that in the deployed position the airbag covers at least a portion of the periphery of the object to be protected mounted on the flying object;
at least one vent hole capable of discharging gas inside the airbag, and for intake of air when internal pressure inside the airbag is negative;
a gas generator which is connected to the airbag and is capable of supplying gas into the airbag to inflate the airbag when the gas generator is activated;
wherein said vent hole is disposed on a foldable portion of the airbag, such that in said folded position said vent hole is blocked, and in said deployed position said vent holes is exposed allowing air intake.

2. The airbag device for a flying object according to claim 1, wherein the object to be protected mounted on the flying object is any one of a power source of the flying object, a safety device used to protect the flying object and a collision object that collides with the flying object from the impact at the time of collision, a laser surveying device capable of performing surveying, an altitude sensor capable of detecting altitude, an infrared sensor or ultrasonic sensor capable of detecting a distance from the collision object, a camera capable of performing imaging, a black box device that records acquired data, and a flight control device that controls flight of the flying object.

3. The airbag device for a flying object according to claim 1, wherein the airbag is a tubular expandable body which expands so as to cover a portion or the entirety of a periphery of the object to be protected mounted on the flying object when the gas generator is operated.

4. The airbag device for a flying object according to claim 1, wherein the airbag is an expandable body having a dome-like portion which expands so as to cover a portion or the entirety of a periphery of the object to be protected mounted on the flying object when the gas generator is operated.

6. The airbag device for a flying object according to claim 1, wherein an internal pressure value of the airbag is −69.8 kPa to 48.6 kPa after an internal pressure of the airbag exhibits a minimum value.

7. The airbag device for a flying object according to claim 1, wherein one of the objects to be protected mounted on the flying object is a detection device capable of detecting or predicting collision between the flying object and an obstacle existing outside the flying object, and after the detection device detects or predicts the collision between the flying object and the obstacle existing outside the flying object, the detection device transmits an operation signal to the gas generator to operate the gas generator, and controls the airbag to start deployment within 5 ms to 36 ms.

8. The airbag device for a flying object according to claim 7, wherein one of the objects to be protected mounted on the flying object is a detection device capable of detecting or predicting collision between the flying object and an obstacle existing outside the flying object, and a detectable distance from the detection device to the obstacle existing outside the flying object is 0 m to 10 m.

9. The airbag device according to claim 1, wherein when a weight of the obstacle is M [kg], a relative speed with respect to the obstacle at which the airbag is capable of absorbing impact is W [m/s], and a numerical value X [kg^{1/2}·m/s] is M^{1/2}×W, X is 50 to 900.

10. The airbag device for a flying object according to claim 1, wherein the gas generator has a pyro-type gas generating agent and is configured such that the gas is generated by combustion of the pyro-type gas generating agent to flow into the airbag.

11. The airbag device for a flying object according to claim 1, wherein the gas generator comprises a gas-filled container filled with compressed gas and an igniter that has an ignition charge and cleaves the gas-filled container owing to combustion of the ignition charge to make the compressed gas as the gas flow into the airbag.

12. The airbag device for a flying object according to claim 1, wherein at least one of the objects to be protected mounted on the flying object is provided inside an airframe of the flying object, and the airbag is provided inside the airframe of the flying object to be adjacent to the object to be protected mounted on the flying object provided inside the airframe of the flying object.

13. The airbag device for a flying object according to claim 1, wherein said airbag includes a central aperture coupled to said gas generator and configured to allow gas into the airbag.

14. The airbag device for a flying object according to claim 13, wherein said airbag includes a first folding portion and a second folding portion, and wherein in said folded position, said second folding portion is folded on said first folding portion, such that when said airbag is deployed, said second folding portion is unfolded before said first folding portion, and wherein said vent hole is disposed on said second folding portion, and in said folded position, the vent hole is covered by said second folding portion.

15. The airbag device for a flying object according to claim 13, wherein said folded position, an internal volume of said airbag is smaller than the internal volume thereof in said deployed position.

16. The airbag device for a flying object according to claim 15, wherein said gas generator is configured to urge gas into said airbag such that in said folded position, gas inertia urges the airbag to shift to said unfolded position.

17. The airbag device for a flying object according to claim 16, wherein said gas generator is configured such that said gas inertia causes a negative internal pressure inside said airbag when shifting from said folded position to said deployed position.
